(19) United States
(12) Patent Application Publication
(10) Pub. No.: US 2015/0076947 A1
(43) Pub. Date: Mar. 19, 2015

(54) ELECTRICAL MACHINE

(71) Applicant: BAUMUELLER NUERNBERG GMBH, NUERNBERG (DE)

(72) Inventor: MICHAEL VEEH, KLEINRINDERFELD (DE)

(21) Appl. No.: 14/551,304

(22) Filed: Nov. 24, 2014

Related U.S. Application Data
(63) Continuation of application No. PCT/EP2012/002200, filed on May 23, 2012.

(51) Int. Cl. H02K 5/10; H02K 5/16

(52) U.S. Cl. CPC H02K 5/10; H02K 5/163
USPC 310/88

(57) ABSTRACT

An electrical machine has a machine housing, which encloses a machine interior, and a flange bearing shield formed with a shaft feedthrough for a machine shaft. A leakage space that communicates with at least one drain opening is provided in the region of the shaft feedthrough.

### CROSS-REFERENCE TO RELATED APPLICATION

This application is a continuation, under 35 U.S.C. §120, of copending international application No. PCT/EP2012/002200, filed May 23, 2012, which designated the United States; the prior application is herewith incorporated by reference in its entirety.

### BACKGROUND OF THE INVENTION

### Field of the Invention

The invention relates to an electrical machine comprising a machine housing and a flange bearing end plate that has a shaft feedthrough for a machine shaft. The term “electrical machine” is understood to mean an electric motor that for example can be coupled to a transmission. However, the electrical machine can also be a generator.

An electrical machine of this type generally comprises a machine housing and also the bearings that support shaft ends of the machine shaft in such a manner that the shaft ends can rotate and the machine shaft supports the rotor (armature) and the bearings are received by the bearing end plates that cover the machine housing on its outer ends. The output side shaft end that is described as the A-bearing (A-bearing end plate) is generally guided towards the exterior by way of a flange bearing end plate having a shaft feedthrough.

The machine shaft or rather the motor shaft of an electric motor of this type, for example a three-phase synchronous motor, can be coupled to a further unit, for example a pump, by way of a transmission. When using a servomotor-operated hydraulic pump (hydro unit) of this type, it is frequently necessary to arrange or install the electric motor in a vertical position. The motor shaft is thus directed upwards and is guided via the shaft feedthrough to the transmission. The shaft feedthrough at which the machine shaft exits the machine housing forms a specific weak point since fluids, for instance a lubricant, can penetrate by way of the weak point from the transmission into the interior space of the motor or rather of the machine housing if the liquid tightness of the shaft feedthrough is no longer ensured. This is in particular the case after the shaft feedthrough comes to the end of its service life. A suction effect as a result of thermal effects can also cause fluids of this type to undesirably penetrate the interior space of the housing of the machine.

### SUMMARY OF THE INVENTION

It is accordingly an object of the invention to provide an electrical machine which overcomes the above-mentioned and other disadvantages of the heretofore-known devices and methods of this general type and in which fluids, in particular lubricants, are prevented from penetrating the machine or that at the very least defects in liquid tightness that result from components coming to the end of their service life are also reliably detected.

With the foregoing and other objects in view there is provided, in accordance with the invention, a electrical machine, comprising:

a machine housing encompassing a machine interior space;

a flange bearing end plate formed with a shaft feedthrough for a machine shaft; and

a leakage space in fluid communication with at least one outlet opening and formed in a region of said shaft feedthrough.

In other words, the electrical machine comprises a machine housing that encompasses a machine interior space, and the electrical machine also comprises a flange bearing end plate that has a shaft feedthrough, and a leakage space that communicates with at least one outlet opening is provided in the region of the shaft feedthrough. It is preferred that the outlet openings are located in the construction space between the machine and the flange-connected system, for example the transmission. In this manner, it is possible to convey fluids, in particular lubricants, in a purposeful manner and in particular to detect in good time any defects in liquid tightness in the coupled system above the machine.

In accordance with a particularly advantageous further development of the invention, a ring disk is provided that is located within the leakage space and is supported by the machine shaft and is fixed to the shaft. Leakages that flow along the machine shaft are discharged into the leakage space in a purposeful manner by means of the ring disk. During operation of the machine, the ring disk rotates with the machine shaft so that consequently the leakages that are caused as a result of the centrifugal effect are particularly reliably conveyed into the leakage space and from that location are discharged towards the exterior of the machine housing by way of the outlet opening.

The preferably two or more outlet openings are suitably located in a construction space between the machine housing and the outer face of the flange bearing end plate that is remote from the machine interior space. It is particularly preferred that the outlet opening or each outlet opening in the flange bearing end plate is provided independently. The outlet opening or each outlet opening along the machine shaft is located in the region between the machine interior space and the ring disk so that in the case of a vertically aligned machine shaft and machine interior space that is located below the shaft feedthrough, the respective outlet opening is arranged in the longitudinal direction of the machine shaft below the ring disk. Consequently it is ensured that, in particular when the electric motor is installed in a vertical position, fluid that collects in the leakage space can discharge reliably and entirely by way of the corresponding outlet openings. For this purpose, an inclined or sloped outlet opening or stepped contour is particularly expedient within the leakage space so that the leakage space issues from the position of the ring disk into the outlet opening in a downwardly sloped manner.

In a suitable embodiment of the ring disk, the ring disk comprises an outer ring and an inner ring. While the outer ring is preferably made from a non-resilient material, in particular from a sheet steel, the inner ring is embodied in a resilient manner. The ring disk is embodied in such a manner that, when the machine is idle, the inner ring lies with its ring outer edge that is remote from the machine shaft against a housing contour inside the leakage space and lifts up from the housing contour during rotating operation of the machine shaft.

In a further expedient embodiment, the ring disk in particular its metal outer ring is curved in the region of its ring outer edge to form a preferably circumferential axial disk collar. This disk collar suitably engages with its collar outer edge in a housing groove of the housing contour within the leakage space.

In particular in connection with the two-part embodiment of the ring disk having an inner-lying resilient inner ring, a reliable liquid tightness is achieved between the ring disk and the wall of the leakage space and also at that location with respect to the machine shaft in the case of simultaneously particularly low levels of friction of the ring disk during operation of the machine.

In particular, the advantages that are achieved with the invention are that, as a result of providing at least one outlet opening in the region of the interface between the machine housing of an electrical machine and a system that is coupled to the machine housing, in particular a transmission, leakages that occur are discharged and consequently, on the one hand, the penetration of fluid, in particular lubricants, into the machine interior space by way of a shaft feedthrough is reliably prevented. On the other hand, defects in liquid tightness can be reliably detected.

In addition, by way of the outlet opening that issues from a leakage space and is expediently arranged in a flange bearing end plate between the electrical machine and a system that is flange-connected to the electrical machine, for example a transmission, it is thus possible to perform a pressure equalization at the interface between the rotating machine and the attached system.

As a result of avoiding the penetration of fluids by way of the shaft feedthrough into the machine interior space, construction elements for example a brake system or an optical sensor system that are arranged at this location are reliably protected from short circuits or other undesirable influences that are caused by malfunctions as a consequence of penetrating fluid. In connection with the ring disk that suitably functions as a centrifugal disk and is fixed to the shaft, fluids that are guided along the machine shaft from the shaft are collected in the leakage space and are discharged from that location by way of the outlet opening.

Other features which are considered as characteristic for the invention are set forth in the appended claims.

Although the invention is illustrated and described herein as embodied in an electrical machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 illustrates a side view of an electrical machine with a view of an outlet opening for leakages;

FIG. 2 is a longitudinal section taken through the electrical machine along the line II-II in FIG. 1 with a ring disk that is fixed to the shaft in the region of a shaft feedthrough;

FIG. 3 is a detail III of FIG. 2 on an enlarged scale, with the outlet opening that issues from the leakage space; and

FIG. 4 is a view of the ring disk that is fixed to the machine shaft and also of the connection of the ring disk to a housing contour in a partly cross-sectional illustration.

### DETAILED DESCRIPTION OF THE INVENTION

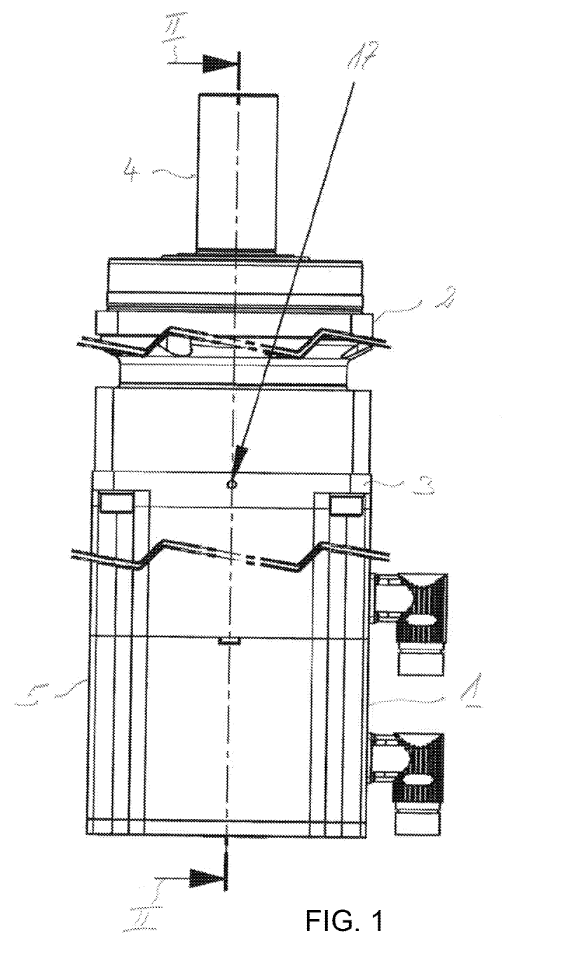

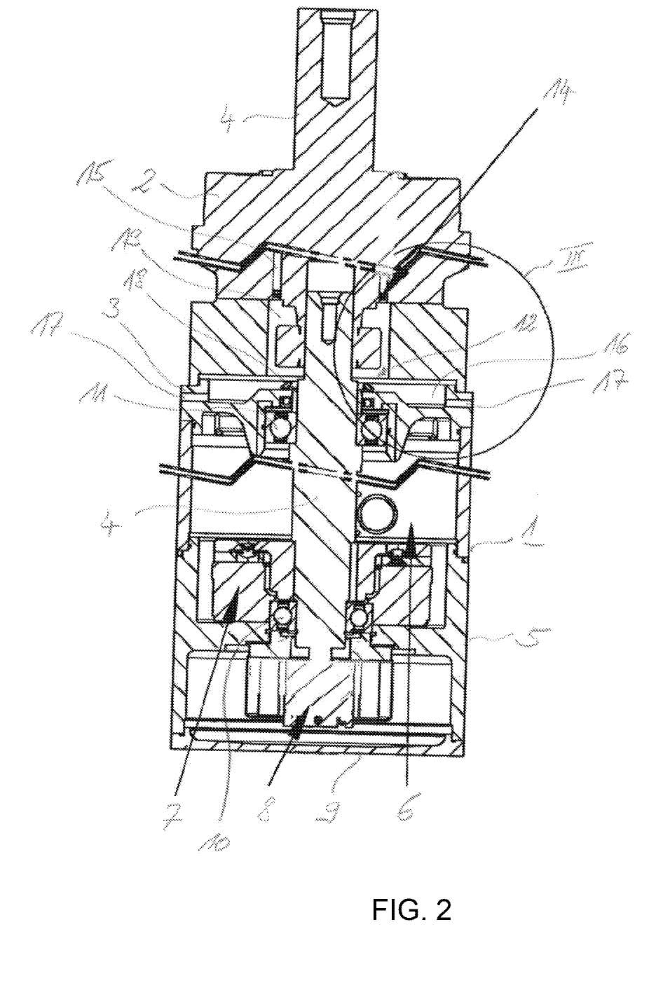

Referring now to the figures of the drawing in detail and first, particularly, to FIGS. 1 and 2 thereof, there is shown an electrical machine 1. The illustrated machine 1 concerns an electric motor in a vertical arrangement with a transmission 2 that is coupled to the electric motor by way of an A-side flange bearing end plate 3 and also by way of a machine shaft 4 that is vertically guided outwards from the transmission. The flange bearing end plate 3 is connected on its front end face to a machine housing 5 that encompasses a machine interior space 6.

In addition to the machine shaft or rather motor shaft 4, the machine interior space 6 receives components that are to be protected against fluids, the components being in particular a braking system 7 and also a sensor system 8. The machine housing 5 is closed by means of a bearing end plate 9 on the front end face (B-side) that lies opposite the flange bearing end plate 3.

The machine shaft 4 that is rotatably mounted within the machine housing 5 in a B-side bearing 10 and also in an A-side bearing 11 is guided by way of a shaft feedthrough 12 by way of the flange bearing end plate 3 out of the transmission 2. At this location, the shaft 4 can be coupled with a unit, for example a hydraulic pump, in order to electromotively drive the same.

The flange bearing end plate 3 forms so to speak the mechanical interface between the electrical machine 1 and the transmission 2. A transmission interior space 13 is sealed in the illustration of FIG. 2 above the flange bearing end plate 3 with a sealing element 14. Further lubricant ducts 15 are located in the axial direction x above the sealing element 14 within the transmission 2.

A leakage space 16 is located in the region of the shaft feedthrough 12 in the flange bearing end plate 3 and in the exemplary embodiment two outlet openings 17 issue from the leakage space and for this purpose pass through the wall of the flange bearing end plate 3. The machine shaft 4 supports a ring disk 18 within the leakage space 17.

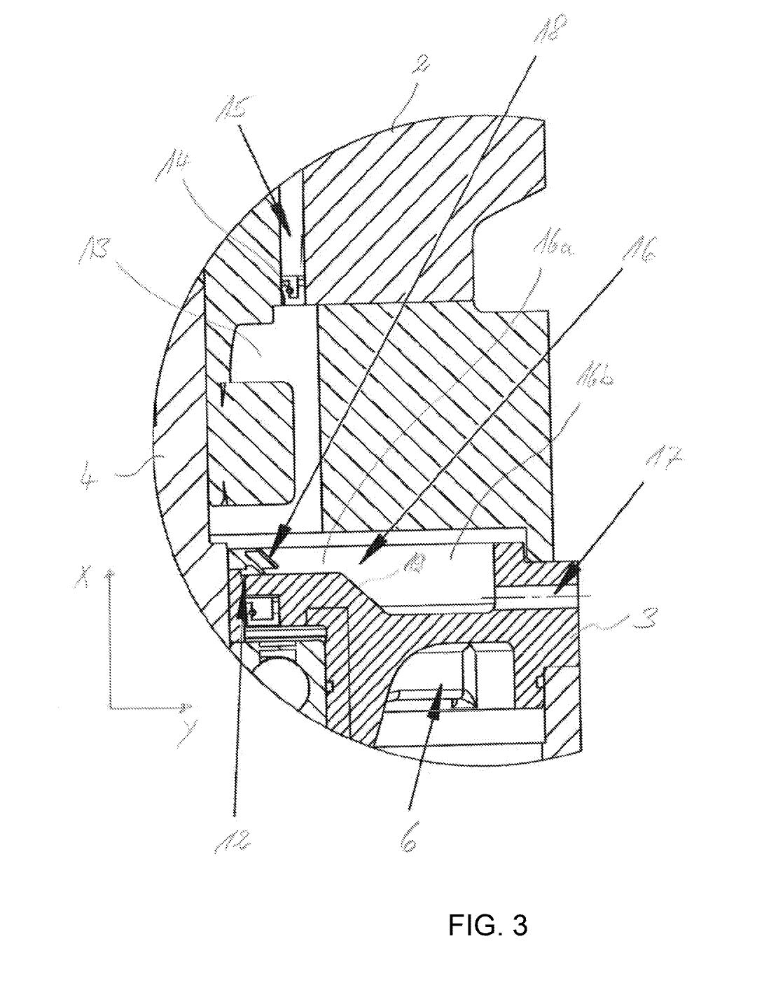

As is quite clearly visible in FIG. 3, the ring disk 18 is located in the region of the shaft feedthrough 12 and at that location in a space region 16a of the leakage space 16, the space region being relatively narrow in the axial direction x. The space region widens over an inclined housing contour 19 of the flange bearing end plate 3 in a downwardly sloped manner to become a space region 16b of the leakage space 16, the space region having a comparatively large volume. The relatively narrow space region 16a of the leakage space 16 extends in the radial direction y as far as the downwardly sloped housing contour 19 and at this location becomes the relatively wide space region 16b that extends in the radial direction y as far as the outlet opening 17, wherein the outlet opening 17 is arranged in the axial direction x below the shaft feedthrough 12 and the ring disk 18 that is located at that location.

The fluids or lubricants that flow out the transmission 2 by way of the interior space 13 and at that location along the machine shaft 4 are forcibly conveyed at the ring disk 18 along into the leakage space 16 and can discharge from that location by way of the outlet opening 18. Leakages of this type are consequently detected as an indication of a defect in liquid tightness for example in the region of the transmission side sealing element 14 so that the sealing element 14 that is leaking for example as a result of coming to the end of its service life can be replaced.

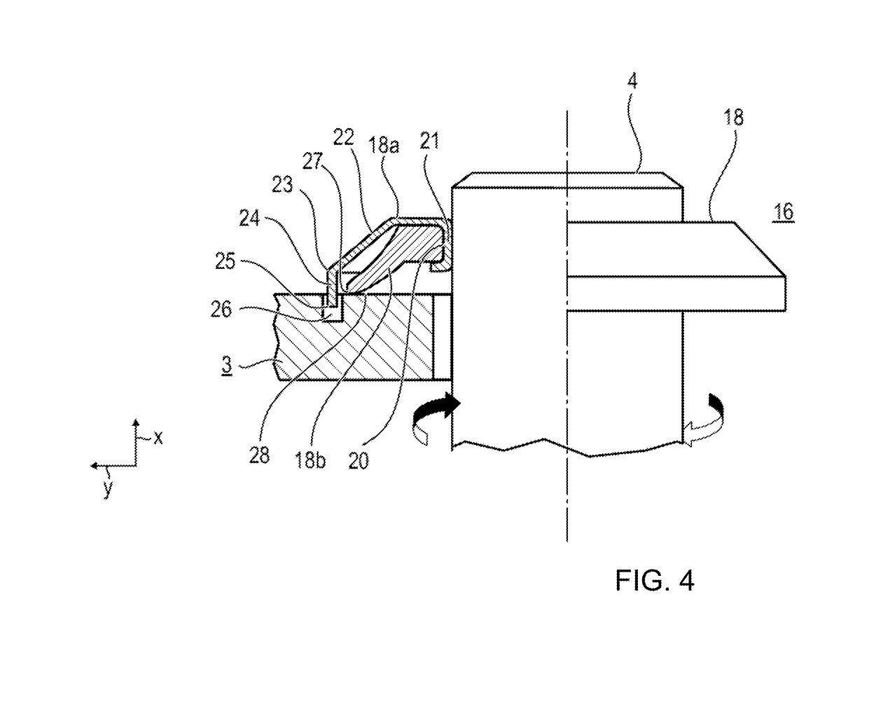

FIG. 4 illustrates a preferred embodiment of the ring disk 18. The ring disk comprises a rigid outer ring 18a that is embodied for example from stainless steel and a resilient inner ring 18b that is embodied for example from a plastic-resilient synthetic material. The inner ring lies with its ring inner edge 20 that is facing the machine shaft 4 within a U-shaped disk contour 21 of the outer ring 18a. The ring disk 18 is connected to the machine shaft 4 in a positive locking and/or non-positive locking manner with the outer face of the region between the limbs of this U-shaped disk contour 21 of outer ring 18a and consequently is fixed to the shaft.

An inclined outlet contour 22 of the outer ring 18a connects to the U-shaped disk contour 21. A collar contour that extends in the axial direction x as an axial disk collar 24 connects to the inclined outlet contour 22 by way of a curved region 23. The ring outer edge 25 of the outer ring 18a of the ring disk 18 that is formed as a result of the arrangement engages in a housing groove 26 of the flange bearing end plate 3 with sufficient radial and axial clearance for the ring disk 18 to rotate without interference and in particular without friction.

The resilient inner ring 18b of the ring disk 18 is designed and arranged within the outer ring 18a in such a manner that, when the machine 1 is idle, the ring outer edge 27 of the inner ring 18b lies in the radial direction y in front of the housing groove 26 in a sealing manner against the flange end bearing plate 3 or rather against a housing contour 28 at that location.

During the operation of the machine 1, this ring outer edge 27 of the inner ring 18b lifts up from the housing contour 28 as a result of the rotation of the machine shaft 4 with the consequence that the ring disk 18 rotates in a practically friction-free manner. By virtue of the fact that the disk collar 25 of the ring disk 18 sits in the housing groove 26, fluid, in particular lubricant, is prevented in a particularly reliable manner from penetrating in the between the housing contour 28 and the ring disk 18 and from that location along the machine shaft 4 into the machine interior space 6 during operation of the machine 1.

The following is a summary list of reference numerals and the corresponding structure used in the above description of the invention:
1 Electrical Machine/Electric Motor
2 Transmission
3 Flange Bearing End Plate
4 Machine/Motor Shaft
5 Machine Housing
6 Machine Interior Space
7 Brake System
8 Sensor System
9 Bearing End Plate (B-side)
10 B-side Bearing
11 A-side Bearing
12 Shaft Feedthrough
13 Transmission Interior Space
14 Sealing Element
15 Lubricant Duct
16 Leakage Space
16a Narrow Space Region
16b Wide Space Region
17 Outlet Opening
18 Ring Disk
18a Outer Ring
18b Inner Ring
19 Inclined Stepped Contour
20 Ring Inner Edge
21 U-Shaped Disk Contour
22 Inclined Disk Contour
23 Curved Region
24 Axial Disk Collar
25 Disk Outer Edge
26 Housing Groove
27 Ring Outer Edge
28 Housing Contour
x Axial Direction
y Radial Direction

1. An electrical machine, comprising:
a machine housing encompassing a machine interior space;
a flange bearing end plate formed with a shaft feedthrough for a machine shaft; and
a leakage space in fluid communication with at least one outlet opening and formed in a region of said shaft feedthrough.

2. The electrical machine according to claim 1, which comprises a ring disk supported by and fixed to said machine shaft, and arranged within said leakage space.

3. The electrical machine according to claim 2, wherein said outlet opening is formed in a region between said machine interior space and said ring disk.

4. The electrical machine according to claim 1, wherein said outlet opening is formed between said machine housing and an outer face of said flange bearing end plate remote from said machine interior space.

5. The electrical machine according to claim 1, wherein said outlet opening is formed in the flange bearing end plate.

6. The electrical machine according to claim 2, wherein said machine shaft is vertically aligned and said machine interior space is located below said shaft feedthrough, and wherein said outlet opening is arranged below said ring disk in a longitudinal direction of the machine shaft.

7. The electrical machine according to claim 1, wherein said leakage space issues into said outlet opening by way of an inclined outlet or a stepped contour.

8. The electrical machine according to claim 2, wherein said ring disk is configured, during rotation of said machine shaft, to force a fluid flowing along said machine shaft from said shaft feedthrough into said leakage space.

9. The electrical machine according to claim 8, wherein the fluid is a lubricant.

10. The electrical machine according to claim 2, wherein said ring disk comprises an outer ring made of a non-resilient material and a resilient inner ring held by said outer ring.

11. The electrical machine according to claim 10, wherein said non-resilient material is metal.

12. The electrical machine according to claim 11, wherein said metal is a sheet steel.

13. The electrical machine according to claim 10, wherein said ring disk is mounted to said machine shaft with said resilient inner ring lying with a ring outer edge that is remote from said machine shaft against a housing contour of said leakage space and configured to lift up from said housing contour during a rotation of said machine shaft.

14. The electrical machine according to claim 2, wherein said ring disk is curved in a region of a ring outer edge that is remote from said machine shaft to form a substantially axial disk collar that engages in a housing groove formed at a radial distance from said machine shaft.

15. The electrical machine according to claim 14, wherein said outer ring of said ring disk is curved at the ring outer edge.
